(19) United States
(12) Patent Application Publication
(10) Pub. No.: US 2025/0307862 A1
(43) Pub. Date: Oct. 2, 2025

(54) INFORMATION PROCESSING APPARATUS, INFORMATION PROCESSING METHOD, AND COMPUTER-READABLE MEDIUM

(71) Applicant: CANON KABUSHIKI KAISHA, Tokyo (JP)

(72) Inventor: Yasufumi TAKAMA, Kanagawa (JP)

(21) Appl. No.: 19/084,452

(22) Filed: Mar. 19, 2025

(30) Foreign Application Priority Data
Mar. 29, 2024 (JP) 2024-057619

(51) Int. Cl. G06Q 30/0201; G06T 7/00

(52) U.S. Cl. CPC G06Q 30/0206; G06T 7/0002

(57) ABSTRACT

An information processing apparatus is provided. The apparatus sets information indicating a static evaluation of digital content. The digital content is generated on the basis of three-dimensional shape data indicating a three-dimensional shape of a subject generated using a plurality of captured images obtained by a plurality of image capturing apparatuses. The static evaluation is an evaluation of substance of the digital content. The apparatus determines a dynamic evaluation of the digital content. The dynamic evaluation is an evaluation that can change over time. The apparatus estimates a value of the digital content on the basis of both the static evaluation and the dynamic evaluation.

### BACKGROUND

### Field

The present disclosure relates to an information processing apparatus, an information processing method, and a computer-readable medium, and particularly relates to protecting the rights of creators with respect to digital content.

### Description of the Related Art

Volumetric capture techniques for generating a three-dimensional shape model of a subject using a plurality of captured images obtained by a multi-viewpoint camera are garnering attention. Using a volumetric capture technique makes it possible to generate an image from any desired viewpoint designated in a virtual space (called a “virtual viewpoint image” hereinafter) (Japanese Patent Laid-Open No. 2015-45920).

Meanwhile, blockchain technology that uses non-fungible tokens (NFTs) to prove ownership of digital content is also garnering attention. For example, linking an NFT to digital content, such as a digital item in a virtual space or a computer game, digital artwork, or the like, makes it possible to prove ownership of that digital content. Japanese Patent Laid-Open No. 2023-54812 discloses a method for assessing the value of an NFT linked to a virtual object in a computer game. When the owner of the NFT performs well in the game by manipulating the virtual object to which the NFT has been linked, the owner of the NFT becomes more famous, and the value of the NFT increases. To apply such a mechanism, Japanese Patent Laid-Open No. 2023-54812 discloses assessing the value of an NFT linked to a virtual object on the basis of performance information indicating a player's performance in game activities using the virtual object.

### SUMMARY

According to an embodiment, an information processing apparatus comprises one or more memories storing instructions and one or more processors that execute the instructions to: set information indicating a static evaluation of digital content, the digital content being generated on the basis of three-dimensional shape data indicating a three-dimensional shape of a subject generated using a plurality of captured images obtained by a plurality of image capturing apparatuses, and the static evaluation being an evaluation of substance of the digital content; determine a dynamic evaluation of the digital content, the dynamic evaluation being an evaluation that can change over time; and estimate a value of the digital content on the basis of both the static evaluation and the dynamic evaluation.

According to another embodiment, an information processing method comprises: setting information indicating a static evaluation of digital content, the digital content being generated on the basis of three-dimensional shape data indicating a three-dimensional shape of a subject generated using a plurality of captured images obtained by a plurality of image capturing apparatuses, and the static evaluation being an evaluation of substance of the digital content; determining a dynamic evaluation of the digital content, the dynamic evaluation being an evaluation that can change over time; and estimating a value of the digital content on the basis of both the static evaluation and the dynamic evaluation.

According to still another embodiment, a non-transitory computer-readable medium stores a program executable by a computer to perform a method comprising: setting information indicating a static evaluation of digital content, the digital content being generated on the basis of three-dimensional shape data indicating a three-dimensional shape of a subject generated using a plurality of captured images obtained by a plurality of image capturing apparatuses, and the static evaluation being an evaluation of substance of the digital content; determining a dynamic evaluation of the digital content, the dynamic evaluation being an evaluation that can change over time; and estimating a value of the digital content on the basis of both the static evaluation and the dynamic evaluation.

Further features of the present disclosure will become apparent from the following description of exemplary embodiments (with reference to the attached drawings).

### BRIEF DESCRIPTION OF THE DRAWINGS

FIG. 1 is a block diagram illustrating an information processing system according to one embodiment.

FIG. 2 is a hardware block diagram illustrating an information processing apparatus according to one embodiment.

FIG. 3 is a flowchart illustrating an information processing method according to one embodiment.

FIG. 4 is a schematic diagram illustrating a blockchain.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but all such features are not necessarily required, and multiple such features may be combined as appropriate. Furthermore, in the attached drawings, the same reference numerals are given to the same or similar configurations, and redundant description thereof is omitted.

There is demand for providing digital content generated using volumetric capture technology to users while protecting the rights of the creators of the digital content. To that end, an NFT can be linked to the digital content. Digital content to which an NFT has been linked can be bought and sold between users. On the other hand, it has not been easy to evaluate the value of such digital content to which an NFT has been linked.

An embodiment of the present disclosure can assist a user in trading digital content to which an NFT has been linked by presenting an estimated value of the digital content.

An information processing apparatus according to one embodiment links a non-fungible token (“NFT” hereinafter) to digital content generated from volumetric capture data. An NFT identifies an owner of the digital content to which the NFT has been linked. The information processing apparatus also estimates a value of the digital content to which the NFT has been linked. The value of the NFT linked to the digital content can also be estimated on the basis of the value of the digital content.

Volumetric capture data (called simply “capture data” hereinafter) is three-dimensional shape data expressing the three-dimensional shape of a subject. Such capture data is generated using a plurality of captured images obtained by a plurality of image capturing apparatuses. For example, the capture data can be generated on the basis of information on the position and attitude of the plurality of cameras, and the captured images from the plurality of cameras. The capture data can include a three-dimensional model of the subject. Here, the capture data may include a three-dimensional model of the subject that changes over time. The capture data may also include captured images or video from a plurality of real cameras.

Examples of the digital content generated from the capture data include moving images of a characteristic scene cut out from any real camera video, virtual viewpoint video from a virtual viewpoint designated for the characteristic scene, and the like.

An NFT is one kind of token issued and distributed on a blockchain. Utilizing an NFT makes it possible to give unique value to digital content. Token standards called ERC-721 or ERC-1155 are examples of NFT formats.

### System Configuration

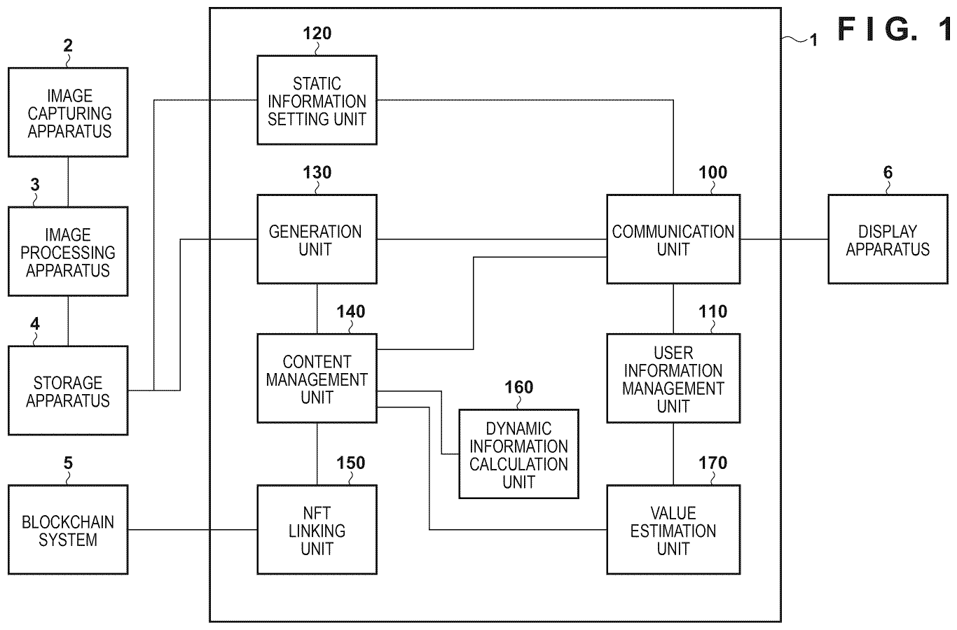

An information processing system according to one embodiment will be described with reference to FIG. 1. FIG. 1 is a block diagram illustrating the configuration of the information processing system according to one embodiment, and an example of the functional configuration of an information processing apparatus 1. The information processing system includes the information processing apparatus 1, an image capturing apparatus 2, an image processing apparatus 3, a storage apparatus 4, a blockchain system 5, and a display apparatus 6.

The information processing apparatus 1 generates digital content from capture data. The information processing apparatus 1 also links an NFT to the digital content. Furthermore, the information processing apparatus 1 manages the information on the trading of the digital content to which the NFT has been linked. Note that a plurality of NFTs can be linked to a single item of digital content. Herein, selling digital content is equivalent to selling an NFT. In other words, a plurality of NFTs can be sold for a single item of digital content. The information processing apparatus 1 can also estimate the value of the digital content. As will be described later, the information processing apparatus 1 can estimate the value of the digital content on the basis of information accompanying the capture data, the sales of the digital content, and the like.

The image capturing apparatus 2 includes a plurality of cameras. The plurality of cameras are installed to capture images of a subject in an image capturing region from different directions, for example. Each camera has an identification number for identifying that camera. Note that the cameras need not be installed over the entire periphery of the subject. For example, due to constraints on installation locations or the like, the cameras may be installed only in some directions with respect to the subject. The number of cameras is not limited. For example, when capturing images of a game such as soccer or rugby, several tens to several hundreds of cameras can be installed around the stadium. The image capturing apparatus 2 may also include a plurality of cameras having different view angles, such as a combination of telephoto cameras and wide-angle cameras.

The cameras are synchronized according to a single instance of real-world time information. Image capture time information is then added to the captured image of each frame constituting the video captured by each camera. Furthermore, each camera can generate a foreground image from a captured image. The foreground image is an image generated by extracting a subject region (a foreground region) from the captured image. The subject extracted as the foreground region is, for example, a dynamic subject (a moving object). The moving object is a subject that moves (changes position or shape) when images thereof are captured from the same direction in time series.

A person, such as a player or a referee on a field where a game is held, can be given as an example of the moving object. In addition to a person, a ball or the like can be given as an example of the moving object, in the case of a ball game. A singer, actor, performer, presenter, or the like can be given as an example of a moving object in a concert or an entertainment event.

In the present embodiment, one computing apparatus is connected to each of the cameras included in the image capturing apparatus 2. However, a plurality of cameras may be connected to a single computing apparatus. The computing apparatus can hold state information such as the position, attitude (orientation and image capturing direction), focal length, optical center, distortion, F-number, and the like of the camera. Camera parameters related to the position and attitude (orientation and image capturing direction) of the camera are what are known as “external parameters”. The parameters related to the focal length, image center, and distortion of the camera are what are known as “internal parameters”.

The image processing apparatus 3 can obtain the foreground image and the camera parameters from the image capturing apparatus 2. The image processing apparatus 3 then estimates the three-dimensional shape of the subject on the basis of this information, and generates three-dimensional shape information expressing the three-dimensional shape of the subject. The image processing apparatus 3 sends the information generated in this manner to the storage apparatus 4 as capture data.

Note that the image processing apparatus 3 may process the captured images, instead of the image capturing apparatus 2 processing the captured images as described above. In this case, the image processing apparatus 3 receives a captured image from each of the cameras and generates a foreground image. Alternatively, the image processing apparatus 3 may obtain a captured image that has been captured in advance and stored in an auxiliary storage apparatus (not shown), and generate a foreground image.

Additionally, the image processing apparatus 3 may calculate the camera parameters, instead of obtaining the camera parameters from the image capturing apparatus 2. In this case, for example, the image processing apparatus 3 extracts feature points from a marker image captured by each of the cameras in advance for camera calibration (e.g., a captured image of a checkerboard), and associates the feature points among the cameras. The image processing apparatus 3 can then calculate the camera parameters by optimizing the camera parameters of the respective cameras to minimize error among the corresponding feature points when the feature points are projected on the respective cameras. The method for optimizing the camera parameters is not particularly limited. Note that the image processing apparatus 3 may obtain the camera parameters in synchronization with the captured image, or asynchronously from the captured image, if necessary. The camera parameters may also be obtained or generated during preliminary preparations.

The image processing apparatus 3 can estimate the three-dimensional shape information on the basis of the foreground image and the camera parameters. The three-dimensional shape information can be expressed as a set of points having three-dimensional coordinates (“point cloud model” hereinafter), a mesh model having triangular or square elements, or the like. The image processing apparatus 3 may also calculate a color for each point in the point cloud model, or for each element of the mesh model. The image processing apparatus 3 can add colors calculated in this manner to the three-dimensional shape information as texture information. To generate the texture information, the image processing apparatus 3 can, for example, convert the three-dimensional coordinates of the points or elements into image coordinates on a captured image according to the camera parameters of each camera. If the post-conversion coordinates are within the foreground region, the image processing apparatus 3 can obtain the pixel value at the post-conversion image coordinates as color information corresponding to the point or element. If the post-conversion image coordinates are within the foreground region of a plurality of captured images by a plurality of the cameras, the image processing apparatus 3 can mix colors through a method such as, for example, calculating an average of the corresponding pixel values in the plurality of captured images.

The storage apparatus 4 stores the foreground image generated by the image processing apparatus 3, the camera parameters, and the three-dimensional shape information as capture data. Note that the storage apparatus 4 can store time-series foreground images, camera parameters, and three-dimensional shape information. The storage apparatus 4 may generate and store new information on the basis of this information. Skeleton information can be given as an example of the new information. The skeleton information is information expressing a skeleton of the subject. The skeleton information can be expressed as positions or angles of joints of the subject. The joints of the subject and the connection relationships among the joints can be set in advance.

The blockchain system 5 registers digital content in the blockchain in response to a request from the information processing apparatus 1. At that time, the blockchain system 5 can issue an NFT for the digital content. In this manner, the blockchain system 5 links an NFT for the digital content. The blockchain system 5 can issue the number of NFTs for the digital content as determined by the creator of the digital content. For example, if 500 NFTs are issued, a maximum of 500 people can own the digital content. To improve the asset value of the digital content, the rarity of the digital content can be increased by limiting the number of NFTs issued, for example. The NFTs can also be managed with serial numbers.

The display apparatus 6 is a device for displaying screens. The display apparatus 6 can display a user interface generated by the information processing apparatus 1. The display apparatus 6 can also obtain user inputs. The display apparatus 6 can send the obtained user inputs to the information processing apparatus 1. The display apparatus 6 can be a device such as a personal computer, a smartphone, a tablet, or the like. A user can set static information in the capture data using the display apparatus 6. The user can also trade digital content to which an NFT has been linked using the display apparatus 6.

The information processing apparatus 1 includes a communication unit 100, a user information management unit 110, a static information setting unit 120, a generation unit 130, a content management unit 140, an NFT linking unit 150, a dynamic information calculation unit 160, and a value estimation unit 170.

The communication unit 100 communicates with the display apparatus 6. The user information management unit 110 manages user information of users accessing the information processing apparatus 1. For example, the communication unit 100 can obtain the user information of the user of the display apparatus 6 from the user information management unit 110. The communication unit 100 can also control access and functions in accordance with the obtained user information. In the following example, the types of users include creators, who capture the capture data or create digital content, and traders, who trade digital content.

The static information setting unit 120 sets information indicating a static evaluation of the digital content (“static information” hereinafter). The static information setting unit 120 can obtain a user input indicating such static information from the display apparatus 6. The static information setting unit 120 can then set the static information for the digital content. In the present embodiment, the static information indicates a static evaluation of the digital content, which does not change over time. The static information can be information indicating an evaluation according to the substance of the digital content.

The static information may be set in accordance with the type of a scene represented by the digital content. For example, the static information can indicate the rarity of the scene represented by the digital content. A high rarity means that the static evaluation of the digital content is high. The rarity may be set according to the stage of a tournament of a game represented by the digital content, the scale of the tournament, or the like. For example, a higher rarity can be set when the stage is a championship match. A higher rarity can also be set when the tournament is an international tournament.

The static information may be set in accordance with the type of the subject represented by the digital content. A person, a ball, a vehicle, or the like can be given as examples of types of subjects. A person's role, e.g., pitcher, batter, catcher, or the like, can also be given as an example of the type of the subject. The static information may also be set in accordance with the popularity of the subject. A high popularity means that the static evaluation of the digital content is high.

In the present embodiment, the static information setting unit 120 sets the static information for the capture data. The static information for the capture data can be information based on the substance of the capture data, such as the scene represented by the capture data. In this case, the static information setting unit 120 can, on the basis of the static information set for the capture data, set the static information for the digital content generated on the basis of that capture data.

The generation unit 130 generates digital content in accordance with capture data and user instructions. The generation unit 130 can set content generation information used for generating the digital content. For example, the generation unit 130 can set the content generation information on the basis of instructions from the creator. The content generation information can indicate settings for the processing for generating digital content. In other words, the content generation information can indicate a static evaluation of the digital content, such as the type or quality of the digital content. In this manner, in the present embodiment, the content generation information is included in the static information. In other words, the generation unit 130 can also set the static information.

In the present embodiment, the digital content generated by the generation unit 130 is real camera video, a shape model, virtual viewpoint video, or a skeleton model. The real camera video is video generated using a foreground image from the same viewpoint as a selected real camera. The shape model is a shape model expressing a three-dimensional shape of a subject, generated using three-dimensional shape information stored in the storage apparatus 4. For example, if the storage apparatus 4 stores three-dimensional shape information expressing the shape of a plurality of subjects, the generation unit 130 can generate a shape model that is digital content expressing the shape of the corresponding subject. The virtual viewpoint video is video of a subject from a virtual viewpoint set by the creator. The generation unit 130 can generate such virtual viewpoint video using foreground images, three-dimensional shape information, and information about the virtual viewpoint. The skeleton model represents the skeleton of a subject. The generation unit 130 can generate the skeleton model for each subject on the basis of the skeleton information in each of frames.

The content management unit 140 manages the digital content generated by the generation unit 130. The content management unit 140 also manages the static information set for the digital content. The content management unit 140 can furthermore manage the content generation information used to generate the digital content. The content management unit 140 can also manage owner information for the digital content in tandem with the blockchain system 5. An NFT can indicate the owner information of the digital content to which the NFT has been linked. The content management unit 140 can further manage the trading of the digital content, and can further manage a sales history. For example, the content management unit 140 can manage records of a trader purchasing each item of digital content sold by a creator. The content management unit 140 can also manage records of a trader purchasing digital content from another trader.

Note that the content management unit 140 may provide the digital content being managed. For example, the content management unit 140 can send the digital content to the display apparatus 6 for playback. Furthermore, the content management unit 140 may manage a usage status (e.g., the playback status) of the digital content being managed.

The NFT linking unit 150 makes a request to the blockchain system 5 to link an NFT to digital content. The digital content managed by the content management unit 140 can be registered in the blockchain system 5 in this manner. An NFT can also be linked to the digital content managed by the content management unit 140.

The dynamic information calculation unit 160 determines a dynamic evaluation of the digital content, which is an evaluation that can change over time. Information indicating the dynamic evaluation will be called “dynamic information” hereinafter. The dynamic information calculation unit 160 can calculate the dynamic information in accordance with the sales of the digital content, the sales of a digital content group generated on the basis of the same volumetric capture data, and the like.

The value estimation unit 170 estimates the value of the digital content on the basis of both the static evaluation and the dynamic evaluation.

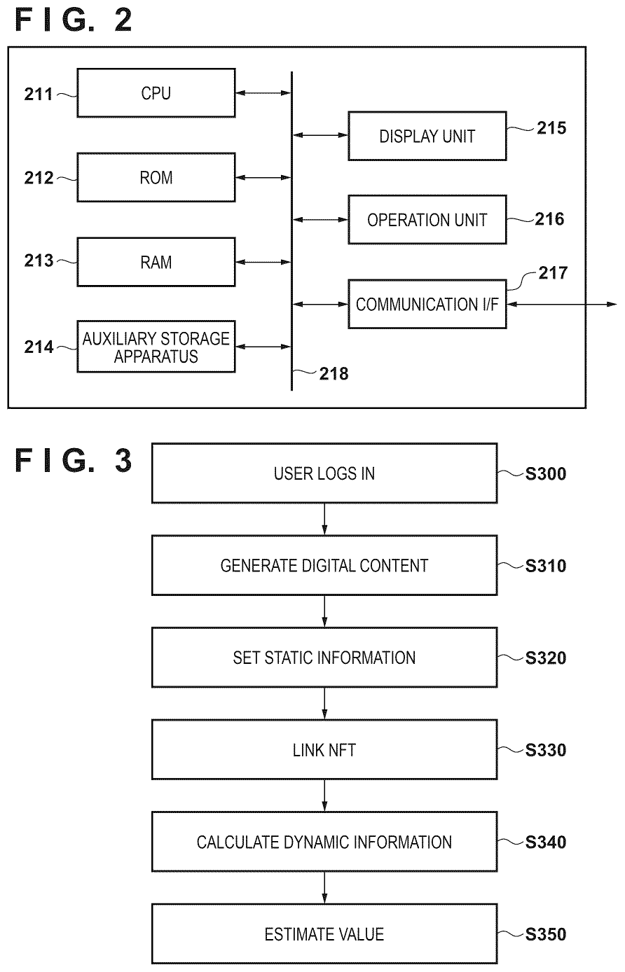

An example of the hardware configuration of the information processing apparatus 1 will be described with reference to FIG. 2. Other apparatuses in the information processing system, such as the image processing apparatus 3, the storage apparatus 4, the blockchain system 5, and the display apparatus 6, can be implemented using similar hardware.

The information processing apparatus 1 includes a CPU 211, a ROM 212, a RAM 213, an auxiliary storage apparatus 214, a display unit 215, an operation unit 216, a communication I/F 217, and a bus 218. The CPU 211 controls the system as a whole using computer programs or data stored in the ROM 212 or the RAM 213. In this manner, the CPU 211 can implement the various functions of the information processing apparatus 1 illustrated in FIG. 1. Note that the information processing apparatus 1 may include one or more pieces of dedicated hardware different from the CPU 211. Such dedicated hardware can execute at least some of the processing by the CPU 211. An Application-Specific Integrated Circuit (ASIC) can be given as an example of the dedicated hardware.

The ROM 212 stores programs and the like that do not need to be changed. The RAM 213 temporarily stores programs or data supplied from the auxiliary storage apparatus 214, data supplied from the exterior via the communication I/F 217, or the like. The auxiliary storage apparatus 214 is a hard disk drive, for example. The auxiliary storage apparatus 214 can store various types of data, such as image data or audio data.

The display unit 215 is a liquid crystal display or an LED, for example. The display unit 215 can display a Graphical User Interface (GUI) and the like through which the user operates the system. The operation unit 216 is a keyboard, a mouse, a joystick, or a touch panel, for example. The operation unit 216 accepts operations made by the user, and inputs various types of instructions to the CPU 211. The CPU 211 can also function as a display control unit that controls the display unit 215 and an operation control unit that controls the operation unit 216. The communication I/F 217 communicates with apparatuses external to the information processing apparatus 1. For example, if the information processing apparatus 1 is connected to external apparatuses over wires, a communication cable is connected to the communication I/F 217. If the information processing apparatus 1 communicates with external apparatuses wirelessly, the communication I/F 217 includes an antenna. A bus 218 connects the units to each other and transmits information among the units. In FIG. 2, the display unit 215 and the operation unit 216 are provided within the information processing apparatus 1. However, at least one of the display unit 215 and the operation unit 216 may be provided as a separate apparatus outside the system of the information processing apparatus 1.

In this manner, the functions of the units illustrated in FIG. 1 and the like can be implemented by a processor such as the CPU 211 executing programs stored in a memory such as the ROM 212, the RAM 213, or the auxiliary storage apparatus 214. Note that the information processing apparatus 1 may be constituted by a plurality of information processing apparatuses connected over a network, for example. In other words, the functions of the information processing apparatus 1 may be provided by a cloud service. Furthermore, one information processing apparatus may have two or more of the functions of the information processing apparatus 1, the image capturing apparatus 2, the image processing apparatus 3, the storage apparatus 4, the blockchain system 5, and the display apparatus 6.

### Processing Flow

Processing performed by the information processing apparatus 1 according to one embodiment will be described hereinafter with reference to the flowchart in FIG. 3. By performing the following processing, the information processing apparatus 1 can estimate the value of digital content to which an NFT has been linked.

In step S300, the user logs in to the information processing apparatus 1 through the display apparatus 6. At this time, the communication unit 100 sends account information entered by the user to the user information management unit 110. The user information management unit 110 verifies the account information that has been sent with account information being managed. The user information management unit 110 then sends a verification result to the display apparatus 6 through the communication unit 100. If the verification succeeds, the user information management unit 110 sets the account of the user to a logged-in state. If the user is a new user, the user information management unit 110 prompts the user to enter a username and financial account information for trading digital content through the display apparatus 6. The user information management unit 110 also causes the user to select “creator”, “trader”, or another type as the type. The user information management unit 110 then creates an account on the basis of the entered information. The following will describe a case where a user, who is a creator, logs in to the information processing apparatus 1.

In step S310, the generation unit 130 generates digital content using capture data stored in the storage apparatus 4. The creator first searches for a characteristic scene in the capture data stored in the storage apparatus 4. In the present embodiment, the creator searches for a scene corresponding to a portion of the time in the scenes expressed by the capture data. The creator then registers a start time and an end time of the scene in the information processing apparatus 1 as scene information. When registering the scene information, the generation unit 130 automatically issues a scene ID for identifying the scene. The scene ID is assigned to the generated digital content. The creator may select the scene information set by the other creator.

The creator enters the type of the digital content to be created into the information processing apparatus 1. The creator further enters content generation information specifying the processing for generating the digital content into the information processing apparatus 1. Note that the content generation information may include scene information.

For example, when generating real camera video as the digital content, the generation unit 130 accepts a camera ID and scene information as the content generation information. When the content generation information is entered, the generation unit 130 generates real camera video on the basis of the foreground image. The generation unit 130 then sends the real camera video along with the content generation information to the content management unit 140.

When generating virtual viewpoint video as the digital content, the generation unit 130 accepts information designating a virtual viewpoint as the content generation information. The generation unit 130 can also accept an image size and scene information (i.e., the start time and the end time of the virtual viewpoint video) as the content generation information. When the content generation information is entered, the generation unit 130 generates the virtual viewpoint video in accordance with the capture data and the content generation information. The generation unit 130 then sends the virtual viewpoint video along with the content generation information to the content management unit 140.

The information designating the virtual viewpoint may be information on a trajectory of the virtual viewpoint in time series (called a “virtual camera path” hereinafter). The creator can enter such information by manipulating the virtual viewpoint using a controller (not shown). For example, when the creator manipulates the virtual viewpoint, the generation unit 130 can send the virtual viewpoint video as seen from that virtual viewpoint to the display apparatus 6. The creator can then designate the virtual camera path while viewing the virtual viewpoint video displayed in the display apparatus 6. The virtual viewpoint video generated at this time may be low-resolution video for manipulating the virtual viewpoint. Such a configuration can be expected to shorten the processing time and reduce the latency for designating the virtual camera path. When the creator designates the virtual camera path in this manner, the generation unit 130 generates the virtual viewpoint video in accordance with the designated virtual camera path. This virtual viewpoint video is virtual viewpoint video for final output, and can have a higher resolution than the video for manipulating the virtual viewpoint.

When generating a shape model as the digital content, the generation unit 130 accepts the scene information as the content generation information. The generation unit 130 then generates a shape model of a subject from between the start time and the end time. The creator may select a method for generating the shape model at this time. If the selected method is a method that can generate the shape information with better accuracy than the method used to generate the three-dimensional shape information stored in the storage apparatus 4, the generation unit 130 can regenerate the three-dimensional shape information. The generation unit 130 can then generate the shape model on the basis of the regenerated three-dimensional shape information.

A method such as visual hull or photo hull can be given as an example of a method for generating a point cloud model that represents a three-dimensional shape. When visual hull, recessed regions of the subject cannot be expressed, which increases shape error. Using photo hull, however, reduces shape error. Obtained depth values can furthermore be used to reduce shape error even more. The value of the digital content can therefore be set in accordance with the selected shape generation method, as will be described later.

When generating a point cloud model expressing a three-dimensional shape, the intervals between point clouds can be set. The accuracy of the generated model increases as the interval between the point clouds decreases. Meanwhile, when generating a mesh model expressing a three-dimensional shape, the number of triangular or square patches constituting the mesh can be set. The shape of the subject can be approximated more accurately as the number of patches increases. The resolution of textures applied to the mesh can also be set when generating a mesh model.

When a plurality of subjects are present in a scene, the generation unit 130 can separate the three-dimensional shape information on a subject-by-subject basis. The generation unit 130 can also assign model IDs to shape models on a subject-by-subject basis. Points or patches which are adjacent to each other can be thought of as representing a single model. By scanning all the points or patches on the basis of such criteria, the generation unit 130 can separate the three-dimensional shape information into shape models on a subject-by-subject basis.

As described above, when generating a point cloud model, the content generation information can include the method for generating the model and the interval between point clouds. When generating a mesh model, the content generation information can also include the number of meshes, the resolution of textures, and the method for generating the model. The generation unit 130 then sends the shape model along with the content generation information to the content management unit 140.

When generating a skeleton model as the digital content, the generation unit 130 accepts the scene information as the content generation information. The generation unit 130 then generates the skeleton model using the skeleton information stored in the storage apparatus 4 from the start time to the end time. When a plurality of subjects are present in the scene, the generation unit 130 can generate skeleton models on a subject-by-subject basis. The generation unit 130 can also assign model IDs to skeleton models on a subject-by-subject basis.

Using a smaller number of joints makes it possible to generate the skeleton model more quickly. However, using a greater number of joints makes it possible for the skeleton model to express finer movements. For example, increasing the number of joints makes it possible to express movements more closely resembling the movement of a person, as well as movement of smaller parts such as the fingers. Accordingly, when generating a skeleton model, the content generation information can include the number of joints. If, for example, the number of joints is 20 or less, the generation unit 130 can generate a basic skeleton model expressed by only the joints between larger bones, such as the pelvis, the first and second parts of the spine, the base of the neck, the throat, the head, the shoulders, the elbows, the wrists, the hip joints, the knees, the ankles, and the tips of the feet. However, the generation unit 130 can also generate a detailed skeleton model having a higher number of joints. In this case, the number of joints in the hands and feet can be increased. The generation unit 130 then sends the skeleton model along with the content generation information to the content management unit 140.

The generation unit 130 can generate various types of digital content as described above. Furthermore, the generation unit 130 can associate a capture data ID, which identifies the capture data used to generate the digital content, with the digital content as generation source information. Referring to such generation source information makes it possible to track the capture data stored in the storage apparatus 4.

In step S320, the static information setting unit 120 sets the static information of the digital content stored in the storage apparatus 4. The static information setting unit 120 may, on the basis of the static information of the capture data, set the static information of the digital content generated on the basis of the capture data. Such static information of the capture data may be set in advance. For example, static information of the capture data can be set manually by the creator of the capture data, e.g., by the photographer of a captured image used to generate the capture data. For example, when setting the static information on the basis of the rarity of the scene expressed by the capture data, the user can select the rarity from a list including “rare”, “mid”, and “common”. On the other hand, the scale of the tournament corresponding to the capture data may be set as the static information. In this case, the user can set the scale of the tournament from a list including “international tournament” and “national tournament”. Likewise, the stage of the tournament corresponding to the capture data may be set as the static information. In this case, the user can set the stage from a list including “championship match”, “semifinal”, or another stage.

Such a list can be set in advance. In addition, value information corresponding to the items included in each list can be registered in advance. For example, the user can register “tournament scale” as a type of static information. “International tournament” and “national tournament” can then be registered as specific items indicating the tournament scale. The user can then register value information corresponding to each of those items. Likewise, individual stages, and value information corresponding to each of the stages, can be registered in advance.

On the other hand, the static information setting unit 120 may set static information that is different from the static information of the capture data as the static information of the digital content. For example, the user may enter the static information of the digital content when creating the digital content. For example, the user may add static information indicating the rarity of the scene expressed by the digital content. The user can also enter static information indicating that the digital content represents the scene of a goal or a home run that determined the outcome of the game. In this manner, the static information setting unit 120 can set the static information entered by the user as the static information of the digital content.

The content management unit 140 registers the digital content generated by the generation unit 130 as described above. The content management unit 140 also registers the static information for the digital content. As described above, the static information can include the static information set by the static information setting unit 120 and the content generation information set by the generation unit 130. The content management unit 140 can assign a content ID to the digital content received from the generation unit 130. The digital content is managed using this content ID in the content management unit 140. The content management unit 140 can also record the capture data ID, the scene ID, and the static information in association with the corresponding data of the digital content. Referring to IDs such as the capture data ID and the scene ID makes it possible to track that the digital content was created from specific scene data of specific capture data managed in the storage apparatus 4. The content management unit 140 can furthermore manage the newest dynamic information of the digital content, which is determined by the dynamic information calculation unit 160 (described later).

In step S330, the NFT linking unit 150 requests the blockchain system 5 to link an NFT to the digital content managed by the content management unit 140. After the generation unit 130 generates digital content, the NFT linking unit 150 can accept a user input indicating whether to link an NFT for the digital content. When an NFT is to be linked, the NFT linking unit 150 can also set the number of NFTs. The NFT linking unit 150 can set the number of NFTs on the basis of a user input.

When it is determined that an NFT is to be linked, the blockchain system 5 issues the set number of NFTs in accordance with the request from the NFT linking unit 150. For example, if the creator wishes to sell 1,000 shape models, the blockchain system 5 issues an NFT to which is assigned an ID indicating a number from 0 to 999. Note that when registering different types of data as a single item of content, such as a combination of a shape model and a skeleton model, the blockchain system 5 can link an NFT to each item of data.

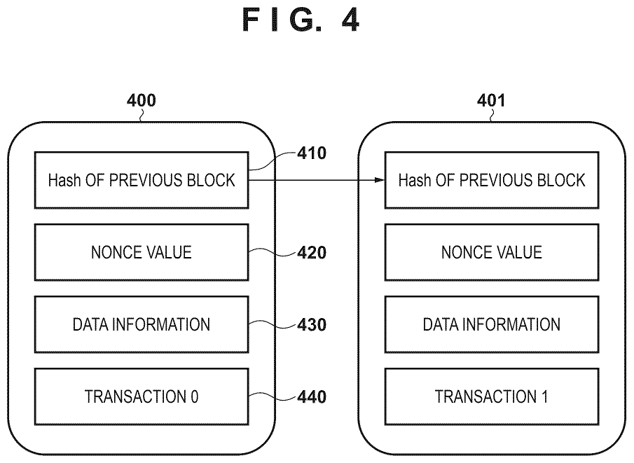

As illustrated in FIG. 4, the NFTs can be managed using a blockchain. FIG. 4 illustrates a first block 400 and a newest block 401. Each block has a hash value 410, a nonce value 420, data information 430, and a transaction 440 of the previous block. The nonce value 420 is used once to generate a block. The data information 430 includes an IP address for specifying the database and a content ID for specifying the data of the digital content. Such a configuration suppresses situations where data having an extremely large size is registered on the blockchain. User information indicating the current owner, e.g., a user ID, is written in the transaction 440 as information indicating a transaction of the content. The description of a smart contract (the execution of an automatic contract with the purchaser of the digital content) may also be registered in the blockchain. For example, writing the user ID of the creator and whether the right to pursue is exercised in the smart contract enables the creator to earn revenue each time the digital content is bought or sold. Additionally, writing an expiration date for the use of the content data in the smart contract makes it possible to revoke the purchaser's ownership after the set expiration date. Digital content to which an NFT has been linked in this manner is managed by the content management unit 140 in a state in which ownership can be proven.

In step S340, the dynamic information calculation unit 160 determines a dynamic evaluation of the digital content. The dynamic evaluation is information that changes over time. Information indicating the dynamic evaluation will be called “dynamic information” hereinafter. The dynamic information is used to estimate the value of the digital content (or the value of the scene expressed by the digital content). To calculate such dynamic information, the dynamic information calculation unit 160 obtains information about the digital content from the content management unit 140. The dynamic information calculation unit 160 can then calculate the dynamic information as follows. The dynamic information calculation unit 160 may calculate the dynamic information according to the type of the content. The dynamic information calculation unit 160 can perform the dynamic information calculation processing periodically. The dynamic information is updated each time the calculation processing is performed. In one embodiment, the dynamic information is set independent of the substance of the content. Note that the dynamic information calculation unit 160 can perform a dynamic evaluation based on the sales, the number of items of digital content, or the like in accordance with the digital content managed by the content management unit 140, a transaction history thereof, or the like. On the other hand, the dynamic information calculation unit 160 may perform such a dynamic evaluation taking into account digital content managed by another apparatus, a transaction history thereof, or the like.

The dynamic information calculation unit 160 can calculate the dynamic information in accordance with the sales of the digital content. The dynamic information calculation unit 160 can also calculate the dynamic information in accordance with a transaction history of the digital content. For example, the dynamic information calculation unit 160 can determine the dynamic evaluation in accordance with the number times the digital content has been bought and sold.

To be more specific, the dynamic information calculation unit 160 can determine the dynamic evaluation in accordance with the number of times digital content offered by the information processing system has been sold. This number can be the number of times the digital content has been sold by the creator to the trader. Note, however, that in the following example, the dynamic information calculation unit 160 does not calculate the dynamic information according to information about a monetary amount. For example, the dynamic information calculation unit 160 does not calculate the dynamic information in accordance with a price of the digital content.

As a specific example, the dynamic information calculation unit 160 can calculate the dynamic information according to a ratio of the number of NFTs offered by the information processing system to the number of NFTs actually sold (a sales rate). For example, if 1,000 NFTs linked to digital content are offered, and 100 are actually sold, the sales rate is 0.1. The sales rate is maximum when the NFT sells out. The dynamic information calculation unit 160 can set the dynamic evaluation to be higher as the sales rate increases.

The dynamic information calculation unit 160 can further calculate the dynamic information in accordance with the number of sales per unit of time of the NFTs offered by the information processing system. As a specific example, if 1,000 NFTs are offered, and it takes 100 days for the NFTs to sell out, the number of sales per unit of time is 1,000/100 days=10/day. Furthermore, if it takes 100 days for ten items of content on offer to sell out, the number of sales per unit of time is 10/100 days=0.1/day. The dynamic information calculation unit 160 can set the dynamic evaluation to be higher as the number of NFTs sold per unit of time increases.

The dynamic information calculation unit 160 can also calculate the dynamic information in accordance with the number of days required for the NFTs offered by the information processing system to sell out (a sellout time). The dynamic information calculation unit 160 can set the dynamic evaluation to be higher as the sellout time decreases. In particular, among a plurality of items of digital content that are of the same type and to which the same number of NFTs have been linked, the dynamic information calculation unit 160 can set a higher dynamic evaluation for the digital content that sells out sooner.

The dynamic information calculation unit 160 can also calculate the dynamic information in accordance with the number of times an NFT has been bought and sold among users (a number of trading). One trade corresponds to one user purchasing an NFT offered by another user, and the ownership of the digital content to which the NFT has been linked shifts to the purchasing user. The number of trading is the number of times such trades have been made. The dynamic information calculation unit 160 can set the dynamic evaluation to be higher as the number of trading of an NFT among users increases. The dynamic information calculation unit 160 can set a higher dynamic evaluation for the digital content as the number of trading increases after the first 1,000 NFTs on offer have sold out.

The method by which the dynamic information calculation unit 160 calculates the dynamic information of the digital content is not limited to the method based on the transaction history as described above. For example, the dynamic information calculation unit 160 may calculate the dynamic information on the basis of information about the subject indicated by the digital content. The information about the subject may be an evaluation of the subject. For example, the information about the subject may be the popularity of the subject. If the subject is a player, the information about the subject may be a record held by the player. The information about the subject may therefore change from day to day. The popularity of a featured player in the scene expressed by the digital content can be set.

The popularity of the subject can be expressed by the number of items of digital content generated for the subject. For example, the popularity of a player can be set in accordance with the number of items of digital content showing the player. For a player whose popularity is set for the first time, the photographer of the captured image may set an initial value for the popularity in advance. Alternatively, for a player whose popularity is set for the first time, the average value of the popularity of all players may be set as the initial value. The dynamic information calculation unit 160 then counts, for each player, the number of items of generated digital content which indicate the player. The number of items of digital content counted in this manner can be used as the popularity of a player. To count the number of items of digital content, the creator can associate player information with the digital content when generating the digital content. A period for counting the number of items of content may be set as well. For example, the period for counting may be one week. The dynamic information calculation unit 160 can count, for each player, the number of items of digital content, indicating that player, that have been generated during the counting period. This method makes it possible to determine whether the player is becoming more popular or less popular.

The dynamic information calculation unit 160 may also calculate the dynamic information on the basis of an evaluation of the capture data used to generate the digital content. The evaluation of the capture data can be an evaluation that can change over time. For example, the capture data can be evaluated in accordance with the number of items of digital content generated on the basis of the capture data. The capture data can also be evaluated in accordance with the sales of digital content generated on the basis of the capture data. Furthermore, the capture data can be evaluated in accordance with the number of traders who own digital content generated on the basis of the capture data. A high number of items or good sales of digital content generated on the basis of the capture data indicates a high evaluation of the capture data. Using such a configuration makes it possible to reflect, in the value of the digital content, the sales or trader ownership of other digital content generated using the same capture data.

The dynamic information calculation unit 160 may also calculate the dynamic information in accordance with an evaluation of the creator, i.e., the creator of the digital content. The creator can be evaluated according to their popularity, for example. In the present embodiment, the popularity can be expressed by an evaluation of each creator by the traders. As another example, the popularity can be expressed by the total playback time of the digital content created by the creator.

In step S350, the value estimation unit 170 estimates the value of the digital content. The value estimation unit 170 can estimate the value of the digital content on the basis of both the static evaluation and the dynamic evaluation. To that end, the value estimation unit 170 can obtain the static information and the dynamic information about the content from the content management unit 140. As described above, the static information of the content can include the content generation information. The value estimation unit 170 can estimate a value based on the static information and a value based on the dynamic information. The value estimation unit 170 can then estimate a final value of the digital content on the basis of those values. The value estimation unit 170 can send information about the estimated value of the digital content to the content management unit 140.

A method by which the value estimation unit 170 estimates the value on the basis of the static information set by the static information setting unit 120 will be described first. When the rarity is set as the static information, the value estimation unit 170 can set the value according to the rarity. For example, if the rarity is “rare”, the value estimation unit 170 can set the value to 1.0. If the rarity is “common” (not rare), the value estimation unit 170 can set the value to 0.0. In this example, a higher numerical value expressing the value indicates a higher value.

When the scale of a tournament is set as the static information, the value estimation unit 170 can set the value according to the tournament scale. For example, if the tournament scale is “international tournament”, the value estimation unit 170 can set the value to 1.0. If the tournament scale is “national tournament”, the value estimation unit 170 can set the value to 0.1.

When the stage of a game is set as the static information, the value estimation unit 170 can set the value according to the stage. For example, when the stage is a championship match, a semifinal, or another stage, the value estimation unit 170 can set the value to 1.0, 0.5, and 0.1, respectively. When scene information is set as the static information, the value estimation unit 170 can set the value according to the scene. For example, the value estimation unit 170 can set the value according to the importance of the scene in terms of the result of a game. Specifically, if the scene information indicates a scene showing a normal home run or goal, the value estimation unit 170 can set the value to 0.5. On the other hand, if the scene information indicates a scene showing a home run or goal decisive to the outcome of the game, the value estimation unit 170 can set the value to 1.0.

A method by which the value estimation unit 170 estimates the value on the basis of the content generation information will be described next. When the type of the digital content is real camera video or virtual viewpoint video, the value estimation unit 170 can set the value in accordance with the resolution or framerate. For example, the value can be 1.0 when the resolution of the video is higher than 4K. The value can be 0.5 when the resolution is at least 2K but less than 4K. The value can be 0.1 when the resolution is less than 2K. The number of resolution classifications may be increased in accordance with the resolution of the input video. Similarly, the value can be 1.0 when the framerate of the video is at least 60 fps. The value can be 0.5 when the framerate is 30 fps. The value can be 0.1 when the framerate is less than 30 fps.

When the type of the digital content is a shape model, the value estimation unit 170 can set the value in accordance with the generation method or accuracy of the shape model. For example, the value can be 0.1 when the shape model is generated through visual hull. The value can be 0.5 when the shape model is generated through photo hull. Furthermore, the value can be 1.0 when the shape model has been generated using depth values. Additionally, in the case of a point cloud model, the value can be 1.0 when the interval among point clouds in the shape model is at a minimum. A lower value can be set as the interval among the point clouds increases. For example, the value which is set can be reduced in a linear manner as the interval among the point clouds increases. When the shape model is a mesh model, the value can be set in accordance with the number of triangular or square patches constituting the mesh. For example, the value can be 0.5 when the number of patches used to express the shape of a single subject exceeds a set number. Furthermore, the value can be 1.0 when the resolution of the textures is higher than a set value.

When the type of the digital content is a skeleton model, the value estimation unit 170 can set the value in accordance with the number of joints. For example, the value can be 0.1 when the number of joints is 20 or lower. The value can be 1.0 when the number of joints is higher.

When a plurality of indicators are set as the static information (including the content generation information), the value estimation unit 170 can calculate a statistical value for the value in accordance with the respective types of static information. For example, the value estimation unit 170 can calculate a maximum, an average, or a weighted average of the value based on each of the indicators as the value estimated on the basis of the static information.

Finally, a method by which the value estimation unit 170 estimates the value on the basis of the dynamic information will be described. The value estimation unit 170 can estimate the value in accordance with the dynamic information, such as the sales rate, the sellout time, the number of trading, the popularity of a player, or the popularity of the creator who created the digital content.

For example, when the sales rate is set as the dynamic information, the sales rate can be used as the value. In other words, the sales rate can be thought of as expressing the value of the digital content. For example, the value can be 0.1 when the sales rate is 0.1. The value can be a maximum of 1.0 when the digital content is sold out.

When the sellout time is set as the dynamic information, the value estimation unit 170 can obtain an average number of days it takes for digital content of the same type and for which the same number of NFTs have been offered to sell out. The value estimation unit 170 can compare this average number of days with the sellout time of the digital content. For example, the value can be 1.0 when the sellout time is shorter than the average number of days. The value can be 0.0 when the sellout time is longer than the average number of days. The value can be 0.0 when the digital content has not sold out.

When the number of trading is set as the dynamic information, the value estimation unit 170 can count a maximum number of trading for the same type of digital content. The value estimation unit 170 can then set the value on the basis of a comparison between the number of trading and the maximum number of trading. For example, the value can be 0.2 when the maximum number of trading is 100 and the number of trading of the digital content is 20. The value estimation unit 170 can reset the value for all the digital content each time the maximum number of trading is updated.

When the popularity of a player is set as the dynamic information, the value estimation unit 170 can set the value by calculating a maximum popularity for all players and then calculating the popularity of each player relative to the maximum popularity. In the present embodiment, the popularity is indicated by the number of items of digital content created for each player. The value of the digital content can be set in proportion to the number of items of digital content for each player. Accordingly, the value estimation unit 170 obtains a maximum value for the number of items of digital content for each player. The value estimation unit 170 then calculates a ratio of the number of items of digital content for each player to the obtained maximum value. The value can be 1.0 for the digital content showing the player having the highest popularity. The calculated ratio can also be used as the value of the digital content showing other players. Setting a period during which the popularity is to be calculated, the value can be set according to the popularity for a given week, month, or year, for example.

When the popularity of the creator is set as the dynamic information, the value estimation unit 170 can set the value by calculating a maximum popularity for all creators and then calculating the popularity of each creator relative to the maximum popularity. The value estimation unit 170 calculates a ratio of the popularity of each creator to the obtained maximum popularity. The calculated ratio can then be used as the value of the digital content created by the creator. When a plurality of indicators are set as the dynamic information, the value estimation unit 170 can calculate a statistical value for the value in accordance with the respective types of dynamic information. For example, the value estimation unit 170 can calculate a maximum, an average, or a weighted average of the value based on each of the indicators as the value estimated on the basis of the dynamic information.

As described above, the value estimation unit 170 can estimate the value of the digital content on the basis of both the static information and the dynamic information. The value estimation unit 170 may manage the value of the content estimated on the basis of the static information, and the value of the content estimated on the basis of the dynamic information, separately. The value estimation unit 170 may also manage the value of the content estimated on the basis of the static information set by the static information setting unit 120, and the value of the content estimated on the basis of the content generation information set by the generation unit 130, separately. On the other hand, the value estimation unit 170 may calculate, as the value of the content, a maximum, an average, a weighted average, or a total of the value of the content estimated on the basis of each of the items of information.

A case where the tournament scale is set as the static information and the sales rate is set as the dynamic information will be described as a specific example. In this example, the tournament scale of first digital content is “national tournament”, and the value based on the static information is therefore 0.1. The sales rate of the first digital content is 0.5, and the value based on the dynamic information is therefore 0.5. In this case, the value estimation unit 170 can calculate the average of these values, i.e., 0.3, as the value of the first digital content. Similarly, if the sales rate of second digital content is 0.9, the value estimation unit 170 can calculate the value of the second digital content as 0.5. The value estimation unit 170 can present the value estimated in this manner to traders through the display apparatus 6.

A trader selling the digital content can determine the sales price of the digital content with reference to the value estimated by the value estimation unit 170. For example, the trader can set the sales price of the second digital content higher than the sales price of the first digital content. The trader may use the display apparatus 6 to instruct the content management unit 140 to perform processing for offering the digital content to be purchased at a specific sales price.

Meanwhile, a trader purchasing the digital content can determine whether to purchase the digital content with reference to the value estimated by the value estimation unit 170. The trader purchasing the digital content can also refer to the value estimated by the value estimation unit 170 to determine whether the sales price offered by the trader selling the digital content is high or low. The trader may use the display apparatus 6 to instruct the content management unit 140 and the NFT linking unit 150 to perform processing for purchasing the digital content at the specified sales price, i.e., processing for changing the owner of the digital content.

However, the value estimation unit 170 may determine the sales price of the digital content on the basis of the estimated value. For example, the value estimation unit 170 may determine the sales price of the digital content on the basis of a base price determined according to the type of the digital content and the value of the digital content. In one example, the first and second digital content are shape models of players in a baseball game. In this example, the base price of shape models of players in the baseball game is 1,000 yen. In this case, the value estimation unit 170 can set the sales price of the first digital content to 1,000×0.3, that is, 300 yen. The value estimation unit 170 can then set the sales price of the second digital content to 1,00×0.5, that is, 500 yen. The content management unit 140 may perform the processing for the trader to trade the digital content at the sales price determined in this manner. Note that such a base price may be set as the static information of the digital content. In this case, the static information setting unit 120 can set the base price according to an input made by the creator of the digital content.

The information processing apparatus 1 can generate digital content as described above, and estimate an evaluation of the generated digital content, in accordance with the flowchart in FIG. 3. However, the information processing apparatus 1 may estimate an evaluation of the digital content that has already been generated. In this case, for the digital content that has already been generated, the information processing apparatus 1 may set the static information as in step S320, set the dynamic information as in step S340, and estimate the value as in step S350. For example, if a trader has logged in in step S300, the information processing apparatus 1 can perform processing for re-estimating the value of the digital content owned by that trader. In this case, the static information setting unit 120 may obtain static information previously set for the digital content. On the other hand, because the dynamic information can change, the dynamic information calculation unit 160 can re-calculate the dynamic information of the digital content. Such a configuration makes it possible for the information processing apparatus 1 to present, to the owner of the digital content, a value that is updated periodically.

The information processing system according to one embodiment may control the display of the digital content in accordance with whether the trader owns the digital content. For example, the content management unit 140 can provide the digital content owned by a trader to the display apparatus 6 for display. For example, the content management unit 140 can send, to the display apparatus 6, a virtual viewpoint image to which a texture representing a subject has been applied. Meanwhile, the content management unit 140 can send digital content not owned by the trader to the display apparatus 6 to be displayed at a lower quality. For example, the content management unit 140 can send, to the display apparatus 6, an image in which a wire frame expressing the shape of the subject is displayed. The content management unit 140 may also reduce the quality of the digital content by applying degradation processing such as blurring or binarization to the digital content. The content management unit 140 can send the digital content to the display apparatus 6 after performing processing to reduce the quality in this manner. Such a display of digital content not owned by the trader assists the trader in deciding whether to purchase the digital content.

At this time, the content management unit 140 may present, to the trader, information indicating the value of the digital content estimated by the value estimation unit 170. For example, the display apparatus 6 can display information indicating the value of digital content, which is displayed at a low quality and is not owned by the trader, in association with that digital content. The trader can decide whether to purchase the digital content by referring to this information.

For example, assume that a trader owns the shape model of the pitcher in a particular scene. In this case, the content management unit 140 can send a high-quality image of the pitcher in the scene to the display apparatus 6. On the other hand, assume that the trader does not own the shape model of the batter in the scene. In this case, the content management unit 140 can send a low-quality image of the batter in the scene to the display apparatus 6. Such a configuration enables the trader to know that there is digital content which they do not own in the same scene. Furthermore, assume that the trader does not own the shape model of the pitcher in a subsequent scene. In this case, the content management unit 140 can send a low-quality image of the pitcher in the subsequent scene to the display apparatus 6. Such a configuration enables the trader to know that there is digital content which they do not own in the subsequent scene.

Note that the types of the static information and the dynamic information are not limited to those described herein. The types of information described as examples of the static information may also be updated over time, in which case those types of information can be used as dynamic information. Conversely, the types of information described as examples of the dynamic information may be information which does not change, in which case those types of information can be used as static information. For example, the popularity of the subject may be a fixed value, in which case the popularity of the subject can be used as static information. The popularity of the subject may also be updated according to the number of items of digital content as described above, in which case the popularity of the subject can be used as dynamic information.

According to the foregoing embodiment, the information processing apparatus 1 can estimate the value of digital content. When purchasing or selling the digital content, a trader can determine whether to make a transaction or set the price with reference to the estimated value of the digital content, i.e., the evaluation of the digital content.

### Evaluating Value in Consideration of Content Collection State

A plurality of items of digital content generated from a particular scene can be associated with each other. A method for estimating the value of digital content taking into account the collection status of items of digital content associated with each other will be described hereinafter. A group of items of digital content associated with each other will be called a “collection” hereinafter. In other words, a plurality of items of digital content constituting a single collection are defined. “Collection status” indicates the status of ownership of the digital content constituting the collection by a user.

In the present embodiment, in addition to the capture data ID and the scene ID, the digital content generated by the generation unit 130 is provided with information for identifying other digital content associated therewith. For example, collection information can be added to the digital content. The collection information includes a collection ID added to the digital content to identify the digital content included in a single collection designated by the creator. The collection information further includes a collection list. The collection list is a list of collection IDs of digital content included in the same collection. A collection completeness for the digital content owned by the trader can be calculated on the basis of such collection information.

In this embodiment, the content management unit 140 can manage the collection information in addition to the digital content and the static information. Additionally, when registering new digital content in the blockchain, the NFT linking unit 150 can describe the collection information in the data information on the blockchain. The value estimation unit 170 estimates the value of the digital content on the basis of the static information and the dynamic information. The collection status of the digital content is information that changes over time, and is included in the dynamic information. In other words, in the present embodiment, the value estimation unit 170 determines the dynamic evaluation of digital content owned by a user in accordance with the status of ownership of the digital content constituting the collection by the user.

In this embodiment too, the information processing apparatus 1 can estimate the value of digital content to which an NFT has been linked, according to the flowchart in FIG. 3. The processing of steps S300, S320, and S340 can be performed as described above. The processing of steps S310, S330, and S350 will be described hereinafter.

In step S310, the generation unit 130 generates digital content using capture data stored in the storage apparatus 4, as described earlier. A capture data ID and a scene ID are added to the digital content. This processing can be performed as described earlier. In the present embodiment, the generation unit 130 further adds the collection information to the digital content. A method for adding the collection information to digital content while referring to a scene in which a baseball pitcher and batter face off will be described hereinafter as an example.

When real camera video of this scene is generated, the generation unit 130 sets camera IDs for the real cameras. The generation unit 130 can automatically set the camera IDs of cameras capturing a specific subject (e.g., the pitcher). For example, the information processing apparatus 1 can recognize cameras that have captured the pitcher from images thereof. The generation unit 130 can then select a camera capturing the pitcher at a high resolution from among those cameras. Processing for recognizing the subject from an image can be implemented as facial recognition, uniform recognition, recognition of a throwing motion based on skeleton information, or the like. The creator may also select the desired camera while viewing video from each of the cameras, and enter the camera ID of the selected camera into the system. The camera IDs of cameras capturing the batter can be set in the same manner. The generation unit 130 can generate real camera video of the pitcher and the batter, as described above, on the basis of these camera IDs.

Furthermore, the generation unit 130 assigns a collection ID 0 to the generated real camera video of the pitcher. The generation unit 130 also assigns a collection ID 1 to the real camera video of the batter. The generation unit 130 adds the collection ID 0 and the collection ID 1 to the collection list. In this manner, the collection list includes collection IDs for all the digital content constituting the collection. Adding this information enables an owner who has only the digital content having the collection ID 0 to know that they do not have the digital content having the collection ID 1. The information processing system can also present the missing digital content needed to complete the collection to traders by referring to this information.

When a collection includes a plurality of items of digital content, the generation unit 130 may set a weight for the value for each of the items of digital content. For example, the creator may determine weights in accordance with the popularity of a pitcher and a batter. The generation unit 130 may also set weights in accordance with the popularity of players as described above. Here, the generation unit 130 can set a weight for each item of digital content included in a single collection such that the sum of the weights is 1.0. On the other hand, weights may be set for each of a plurality of collections. The generation unit 130 can send the assigned collection information to the content management unit 140 along with the real camera video and the content generation information.

When generating virtual viewpoint video for this scene, the generation unit 130 accepts information designating a virtual viewpoint as described above, and generates virtual viewpoint video in accordance with the virtual viewpoint. Here, the generation unit 130 may generate a plurality of virtual camera paths. For example, the generation unit 130 can use virtual camera paths indicating the viewpoint of the pitcher and the viewpoint of the batter to generate virtual viewpoint video based on those respective viewpoints. In this case, the generation unit 130 can assign a collection ID 0 to the virtual camera path and the virtual viewpoint video based on the viewpoint of the pitcher. Likewise, the generation unit 130 can assign a collection ID 1 to the virtual camera path and the virtual viewpoint video based on the viewpoint of the batter. The generation unit 130 then adds the collection IDs of the respective virtual viewpoint videos to the collection list.

When a collection of virtual viewpoint videos includes a plurality of virtual viewpoint videos in this manner, the generation unit 130 can set weights for the values of the respective virtual viewpoint videos. For example, if each virtual viewpoint video is virtual viewpoint video from a fixed viewpoint, the generation unit 130 may set the same weight to each virtual viewpoint video. The generation unit 130 may also set a greater weight for virtual viewpoint video based on a dynamic virtual camera path set in accordance with the scene. The generation unit 130 can add this collection information to the virtual viewpoint video. The generation unit 130 can send the assigned collection information to the content management unit 140 along with the virtual viewpoint video and the content generation information.

When generating a shape model for this scene, the generation unit 130 obtains the three-dimensional shape information corresponding to the scene ID set by the creator from the storage apparatus 4. As described earlier, the generation unit 130 may re-generate the three-dimensional shape information. The generation unit 130 then generates the shape model as described above. As described above, the generation unit 130 can generate a shape model for each subject to which a model ID has been assigned by separating the three-dimensional shape information on a subject-by-subject basis. The scene includes a pitcher and a batter, and thus the generation unit 130 can obtain a shape model corresponding to the model ID selected by the creator.

The generation unit 130 can also add the collection information to a shape model. For example, the collection ID assigned to the shape model of the pitcher may be 0. The collection ID assigned to the shape model of the batter may be 1. The generation unit 130 then adds the collection ID 0 and the collection ID 1 to the collection list.

When a shape model collection includes a plurality of shape models, the generation unit 130 can set a weight for the value of each shape model. The generation unit 130 may set the same weight for the shape model of the pitcher and the shape model of the batter. The shape model collection may further include a shape model of a ball. In this case, the generation unit 130 may set the weight on the shape model of the ball lower than the weight on the shape model of the player. The generation unit 130 can send the assigned collection information to the content management unit 140 along with the shape model and the content generation information.

When generating a skeleton model for this scene, the generation unit 130 generates the skeleton model using the skeleton information as described earlier. The scene includes a pitcher and a batter, and thus the generation unit 130 can obtain a skeleton model corresponding to the model ID selected by the creator.

The generation unit 130 can also add the collection information to a skeleton model. For example, the collection ID assigned to the skeleton model of the pitcher may be 0. The collection ID assigned to the skeleton model of the batter may be 1. The generation unit 130 then adds the collection ID 0 and the collection ID 1 to the collection list.

When a skeleton model collection includes a plurality of skeleton models, the generation unit 130 can set a weight for the value of each skeleton model. The generation unit 130 can send the assigned collection information to the content management unit 140 along with the skeleton model and the content generation information.

The content management unit 140 can record such collection information along with the capture data ID, the scene ID, and the static information in association with the corresponding data of the digital content.

Note that a single collection may include different types of digital content, such as, for example, a shape model and a skeleton model. For example, one item of digital content may include a shape model of the pitcher and a skeleton model of the pitcher. The generation unit 130 can assign collection IDs 0 and 1 to the shape model and the skeleton model, respectively, of the pitcher. The collection ID 0 and the collection ID 1 are added to the content list. In this case, an NFT can be linked for each item of the digital content.

In step S330, the NFT linking unit 150 requests the blockchain system 5 to link an NFT to the digital content managed by the content management unit 140, as described earlier. As in the present embodiment, if a single collection includes a plurality of items of digital content, an NFT can be linked for each item of digital content. The number of NFTs linked to each item of digital content included in a single collection may be the same or different. For example, 1,000 NFTs may be issued for the digital content having the collection ID 0, and 2,000 NFTs may be issued for the digital content having the collection ID 1. The rarity of each item of digital content can therefore be changed by changing the number of NFTs.

If a collection includes two items of digital content, processing for presenting the other collection ID may be written in a smart contract registered in the blockchain. In this case, when a trader purchases one item of the digital content, the presence of the other digital content included in the same collection can be presented, and that other digital content can be offered for purchase.

In step S350, the value estimation unit 170 estimates the value of the digital content on the basis of both the static evaluation and the dynamic evaluation. In the present embodiment, the value estimation unit 170 can estimate the value of the digital content using the collection information. In particular, the value estimation unit 170 can estimate the value of the digital content on the basis of the collection status of the digital content. To that end, the value estimation unit 170 can obtain the collection information from the content management unit 140. On the other hand, the value estimation unit 170 may further use the method or methods for estimating the value described earlier.

A method for estimating the value using the collection information will be described hereinafter. In the following example, the value estimation unit 170 estimates the value of a collection including a plurality of items of digital content. After the creator creates the digital content and the blockchain system 5 links an NFT to the digital content, the value estimation unit 170 sets the initial value of the collection. The value estimation unit 170 first determines the number of items of digital content included in the collection by referring to the collection list. The value of the collection is then set on the basis of the weights for the values of the items of digital content.

When a trader purchases the digital content, the value estimation unit 170 obtains the collection ID of other digital content included in the collection on the basis of the collection list. If the trader does not own the digital content corresponding to the collection ID, the value estimation unit 170 can present information about the missing digital content to the trader.

If the trader owns some of the digital content included in the collection, the value of each item of the digital content can be set according to the weight. In this case, the value of the digital content group can be set in accordance with the collection completeness. The value estimation unit 170 can set the value to be greater as the collection completeness increases. The value may be 1.0 if the owner owns all the digital content included in the collection. The value of the digital content group may also be the sum of the weights of the values of the items of digital content.

If all the digital content is present, the trader can designate whether to retain the individual items of digital content separately, or to integrate those items into a single item of digital content. When integrating the digital content in this manner, the trader can continue to own the individual items of digital content. Meanwhile, the content management unit 140 can manage the integrated digital content as new digital content. If a trader or a creator sells a collection including a plurality of items of digital content, the value is set to 1.0. When a plurality of items of digital content are sold individually, the weight of the value of each item of digital content is newly set.

As described above, the value estimation unit 170 can set a value based on a collection status for a collection including a plurality of items of digital content. On the other hand, the value estimation unit 170 may set an estimated value of the collection, for each item of the digital content included in the collection.

The value estimation unit 170 may manage values estimated on the basis of the collection status of the collection, and the values estimated through other methods as described above, separately. The value estimation unit 170 may also calculate, as the value, a maximum, an average, a weighted average, or a total of those values.

A case where a single collection includes a shape model of a pitcher and a shape model of a batter will be described in detail. In this example, 0.6 is set as the weight of the value of the shape model of the pitcher. 0.3 is set as the weight of the value of the shape model of the batter. In this case, if a trader owns only the shape model of the pitcher, the value based on the collection status for the owned shape model is 0.6. Meanwhile, if the trader owns only the shape model of the batter, the value based on the collection status for the owned shape model is 0.3. If the trader owns both shape models, the value based on the collection status for the owned shape model is 1.0. In this manner, when a trader owns a greater number of the plurality of items of digital content constituting a collection, the value estimated on the basis of the collection status of the collection increases. In this specific example, the value based on the static information is 0.1 for the shape model of the pitcher and the shape model of the batter. The sales rate of the shape model of the pitcher is 0.9, and the sales rate of the shape model of the batter is 0.5. Taking a collection rate of the collection into account, if the trader owns only the shape model of the pitcher, the value of the shape models owned is (0.1+0.9+0.6)/3, that is, about 0.53. If the trader owns only the shape model of the batter, the value of the shape models owned is (0.1+0.5+0.3)/3, that is, 0.3. If the trader owns both shape models, the value of the shape model of the pitcher is (0.1+0.9+1.0)/3, that is, about 0.67. The value of the shape model of the batter is (0.1+0.5+1.0)/3, that is, about 0.53. When the trader owns a greater number of the plurality of items of digital content constituting a collection, the value estimated on the basis of the collection status of the collection increases.

As described above, the information processing system according to one embodiment may control the display of the digital content in accordance with whether the trader owns the digital content. For example, of digital content constituting a collection, the content management unit 140 can provide the digital content owned by a trader to the display apparatus 6 for display. Meanwhile, of the digital content constituting the collection, the content management unit 140 can send digital content not owned by the trader to the display apparatus 6 to be displayed at a lower quality. At this time, the content management unit 140 may present, to the trader, information indicating the value of each item of the digital content estimated by the value estimation unit 170. Furthermore, the content management unit 140 may present, to the trader, information indicating the value of the digital content group, or information indicating the value of each item of digital content, when the trader has purchased digital content which they do not own. Such a configuration enables the trader to know a rise in the value of the digital content resulting from owning digital content constituting the collection. The trader can decide whether to purchase the digital content by referring to this information.

According to the present embodiment, when a trader offers digital content for sale, the value of the digital content can be estimated taking into account the collection status.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-057619, filed Mar. 29, 2024, which is hereby incorporated by reference herein in its entirety.

What is claimed is:

1. An information processing apparatus comprising one or more memories storing instructions and one or more processors that execute the instructions to:
set information indicating a static evaluation of digital content, the digital content being generated on the basis of three-dimensional shape data indicating a three-dimensional shape of a subject generated using a plurality of captured images obtained by a plurality of image capturing apparatuses, and the static evaluation being an evaluation of substance of the digital content;
determine a dynamic evaluation of the digital content, the dynamic evaluation being an evaluation that can change over time; and
estimate a value of the digital content on the basis of both the static evaluation and the dynamic evaluation.

2. The information processing apparatus according to claim 1,
wherein the one or more processors execute the instructions to determine the dynamic evaluation in accordance with sales of the digital content.

3. The information processing apparatus according to claim 1,
wherein the one or more processors execute the instructions to determine the dynamic evaluation in accordance with information about a subject represented by the digital content.

4. The information processing apparatus according to claim 3,
wherein the information about the subject indicates an evaluation of the subject.

5. The information processing apparatus according to claim 3,
wherein the information about the subject indicates the number of items of the digital content generated for the subject.

6. The information processing apparatus according to claim 1,
wherein the one or more processors execute the instructions to determine the dynamic evaluation on the basis of an evaluation of the three-dimensional shape data that can change over time.

7. The information processing apparatus according to claim 1,
wherein the one or more processors execute the instructions to determine the dynamic evaluation in accordance with the number or sales of the digital content generated on the basis of the three-dimensional shape data.

8. The information processing apparatus according to claim 1,
wherein the one or more processors execute the instructions to determine the dynamic evaluation in accordance with an evaluation of a creator who created the digital content.

9. The information processing apparatus according to claim 1,
a plurality of items of digital content constituting a collection are defined, and
the one or more processors execute the instructions to determine the dynamic evaluation of digital content owned by a user in accordance with a status of ownership of the digital content constituting the collection by the user.

10. The information processing apparatus according to claim 1,
wherein the static evaluation is set in accordance with a type of a scene represented by the digital content.

11. The information processing apparatus according to claim 1,
wherein the static evaluation is set in accordance with a type of the subject represented by the digital content.

12. The information processing apparatus according to claim 1,
wherein the static evaluation is set in accordance with a setting of processing for generating the digital content.

13. The information processing apparatus according to claim 1,
wherein the one or more processors execute the instructions to set, on the basis of information indicating the static evaluation of the three-dimensional shape data, information indicating the static evaluation of the digital content generated on the basis of the three-dimensional shape data.

14. The information processing apparatus according to claim 1,
wherein the one or more processors execute the instructions to generate the digital content in accordance with the three-dimensional shape data of the subject and a user instruction.

15. The information processing apparatus according to claim 1,
wherein the one or more processors execute the instructions to manage owner information of the digital content.

16. The information processing apparatus according to claim 15,
wherein the one or more processors execute the instructions to manage a trade of the digital content between users.

17. The information processing apparatus according to claim 1,
wherein the digital content is registered in a blockchain and an NFT indicating an owner is linked to the digital content.

18. An information processing method comprising:
setting information indicating a static evaluation of digital content, the digital content being generated on the basis of three-dimensional shape data indicating a three-dimensional shape of a subject generated using a plurality of captured images obtained by a plurality of image capturing apparatuses, and the static evaluation being an evaluation of substance of the digital content;
determining a dynamic evaluation of the digital content, the dynamic evaluation being an evaluation that can change over time; and
estimating a value of the digital content on the basis of both the static evaluation and the dynamic evaluation.

19. A non-transitory computer-readable medium storing a program executable by a computer to perform a method comprising:
setting information indicating a static evaluation of digital content, the digital content being generated on the basis of three-dimensional shape data indicating a three-dimensional shape of a subject generated using a plurality of captured images obtained by a plurality of image capturing apparatuses, and the static evaluation being an evaluation of substance of the digital content;
determining a dynamic evaluation of the digital content, the dynamic evaluation being an evaluation that can change over time; and
estimating a value of the digital content on the basis of both the static evaluation and the dynamic evaluation.
